(19) United States
(12) Patent Application Publication
(10) Pub. No.: US 2009/0193360 A1
(43) Pub. Date: Jul. 30, 2009

(54) SYSTEM AND METHOD OF MONITORING COMPUTER USAGE

(75) Inventor: JULIAN DAVID FREDIN ESCUER, Mexico D.F. (MX)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Wi- Tech S.A. de C. V., Mexico D.F. (MX)

(21) Appl. No.: 12/019,499

(22) Filed: Jan. 24, 2008

(51) Int. Cl. G06F 15/173; G06F 3/048

(52) U.S. Cl. 715/810; 709/224

(57) ABSTRACT

The present invention provides a system and method of monitoring a person's use of a computer. The method includes the steps of providing a website for monitoring the person's use of the computer, identifying an application or site the person is using, detecting when the person begins use of the application or site, and detecting when the person stops use of the application or site. The difference between when the person stops use of the application or the site and when the person begins use of the application or the site is used to determine an amount of time the person used the application or the site.

### FIELD OF THE INVENTION

The present invention relates to a system and method of monitoring computer usage.

### BACKGROUND OF THE INVENTION

Almost everybody these days uses a computer. As such, the computer has become a staple at the workplace or at the home. However, with the advent of the Internet and other applications, computer users are increasingly spending more time surfing the Internet and conducting other non work-related activities or unacceptable activities on their computers while at work. Likewise, children are taught to use computers at a young age. Use of the computer, however, allows children to use applications or sites that their parents may deem inappropriate. Thus, a need exists for a software system that can monitor computers at any given time.

### SUMMARY OF THE PREFERRED EMBODIMENTS

In accordance with one aspect of the present invention, there is provided a method of monitoring an entity's (“entity” is interchangeable with “person” or “user,” or the like) use of a computer. The method includes the steps of providing a website for monitoring the entity's use of a computer, identifying an application or site the entity is using, detecting when the entity begins use of the application or site, and detecting when the entity stops use of the application or site. The difference between when the entity stops use of the application or the site and when the entity begins use of the application or the site is used to determine an amount of time the entity used the application or the site.

In accordance with another aspect of the present invention, there is provided a system for monitoring a computer user's use of a computer by an entity. The system includes a database of at least one computer user. The system also includes a software system for identifying an application or site used by the computer user, identifying when the user began use of the application or site, and identifying when the user stopped use of the application or site. The system further includes means for displaying the application or site used by the computer user. Preferably, the system develops a report of use by application by the entity.

In accordance with another aspect of the invention, there is provided a method of providing computer user monitoring services to an entity. The method includes providing a website for monitoring computer use, providing a list of applications or sites used by the computer user, providing means for selecting the application or the site from the list of applications or sites, providing means for selecting a classification, and providing means for adding filters to the classification.

In accordance with another aspect of the invention, there is provided a method for monitoring a user's use of at least one application software. The method includes the steps of providing a website, providing a database of application software, selecting an application software from the database that is being used by the user at a given time, detecting when the user begins use of the application software, and detecting when the user stops use of the application software. The difference between when the user stops use of the application software and when the when the user begins use of the application software is used to determine a time the user used the application software.

In accordance with another aspect of the invention, there is provided a method of providing computer efficiency information to a person. The method includes the steps of providing a list of computers, determining performance of the computers, determining usage of the computers, and comparing the performance of the computers to the usage of the computers. Preferably, the method includes generating a report of the computer efficiency information.

In accordance with another aspect of the invention, there is provided a system for determining computer efficiency. The system includes a database of computers and a software system for determining computer usage of a computer user and for determining computer performance. The system further includes means for displaying the identities of the computers, as well as means for displaying the usage and performance information of each of the computers.

### BRIEF DESCRIPTION OF THE DRAWINGS

The invention may be more readily understood by referring to the accompanying drawings in which:

FIG. 1 is block diagram of a system for monitoring computer usage in accordance with a preferred embodiment of the present invention;

FIG. 2 is a block diagram of a computer system that may be used for implementing the system for monitoring computer usage of FIG. 1, configured in accordance with a preferred embodiment of the present invention;

FIG. 3 is a network diagram illustrating a network of computer systems that may be used for implementing the system for monitoring computer usage of FIG. 1, configured in accordance with a preferred embodiment of the present invention;

FIG. 4 to FIG. 15 are a series of screenshots illustrating an example of the system for monitoring computer usage of FIG. 1, configured in accordance with a preferred embodiment of the present invention.

### DETAILED DESCRIPTION OF THE PREFERRED EMBODIMENTS

According to the present invention, a system and method for monitoring computer usage (also referred to herein as system and method for “monitoring a person's use of a computer”, a system for “monitoring a computer user's use of a computer by a person”, a system and method “of providing computer user monitoring services to a person,” a system and method for “monitoring a user's use of at least one application software or site,” a system and method of “providing computer efficiency information to a person”, or a system and method for “determining computer efficiency” is provided.

In a preferred embodiment, a person selects one or more computer users to be monitored. For ease of description, the monitored users will be referred to herein as “users”, “computer users,” or “entities” and the person monitoring the users, for example, the supervisor or the parent, will be referred to herein as “person” or “entity.” Preferably, the software system is installed in each of the users' computers. Preferably, the user is not aware that the software system installed on his or her computer. For example, the software system may be an invisible software system. If a user uses more than one computer, the software system may be installed in each computer used. The software system preferably collects information about the hardware and the software installed on the computer at any given time, as well as user activities. When a predetermined amount of time elapses, the information is sent to a secure web server.

Preferably, the method and system for monitoring a user's use of a computer is facilitated by the use of an Internet website. The person preferably logs onto the Internet website from the computer, allowing the person access to the users' usage activities. In a preferred embodiment, the person monitors the users by using a computer either inside or outside a virtual private network. Preferably, the steps of the method can briefly be described as follows: The method comprises identifying an application or site the user is using; detecting when the user begins use of the application or site; and detecting when the person stops use of the application or site (as used herein, “application” or “site” may refer to the application, site, document, and/or file name the user is using). This information is preferably displayed on an Internet website, and initially accessible by the person but not by the user. As such, the method includes determining the amount of time the user has used the application or the site. The system and method of the present invention will be discussed in detail in the following. The system and method of the present invention allow the person to analyze employee's workload balance. For example, the present invention allows the person to determine who has an excessive workload and who can handle more work. In this regard, the present invention allows the company to produce more, and increases productivity and efficiency of workers. Additionally, the system and method of the present invention allows the person to monitor their children's use of a computer and determine if the children are viewing unacceptable sites. Preferably, the software system does not monitor the content of the application or site and/or does not display the content of the application or site to the person.

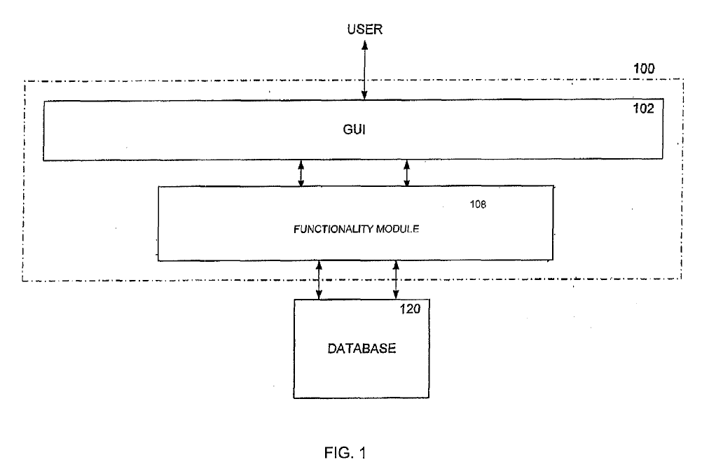

FIG. 1 is a block diagram of a system 100 for monitoring a user's use of a computer in accordance with one preferred embodiment of the invention. The system 100 includes a graphical user interface (GUI) 102 coupled to a functionality module 108. The GUI 102 provides a person with access to the information stored in a database 120 using the functionality provided by the functionality module 108. In a preferred embodiment, GUI 102 is configured either for the home or the office. Preferably, the GUI 102 configured for the home allows parents to monitor computer use of their kids, and the GUI 102 configured for the office allows supervisors to monitor computer use of their employees. As such, it will be understood that the discussion herein that pertains to one interface, i.e., the office, also pertains to the interface configured for the home. Further, as described below, in one preferred embodiment, the database 120 stores information in one or more related databases that are logically grouped by predetermined areas. These areas may be, for example, names of computer users monitored, applications/sites, computers monitored, etc. As used herein, “database” should be understood to cover reference to a single database or a collection of databases. It is to be understood that information may be stored or arranged using a variety of data storage software and hardware techniques known to those of ordinary skill in the art in database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp. In addition, the inventive system may include a software system for (i) identifying an application or site used by the computer user; (ii) identifying when the user began use of the application or site; and (iii) identifying when the user stopped use of the application or site. In one embodiment, the system may include a software system for determining computer usage of a computer user, for determining computer efficiency, and/or for identifying the hardware and software installed on the computer.

Still referring to FIG. 1, the database 120 is preferably accessible by the functionality provided by the functionality module 108. The person accesses the functionality module 108 through the GUI 102, as described herein, which is described through a series of exemplary screenshots of what a person would see on a preferred computer display. In a preferred embodiment, the functionality module 108 includes means for: identifying an application or site used by the computer user, identifying when the user began use of the application or site, and identifying when the user stopped use of the application or site. Subsequently, the identified application or site and the time the. application or site was used by the user may he displayed on the GUI 102. If the user starts, stops, and starts the application again, the inventive system will monitor the second stop too and provides additive amounts of use for a given time period. In a preferred embodiment, the data generated by the functionality module 108 and/or software system may be exported and/or imported into other applications or sites, or off-line, in any way the person needs. For example, the data generated may be exported and/or imported in order to generate reports, as back-up, or to process the data in any way.

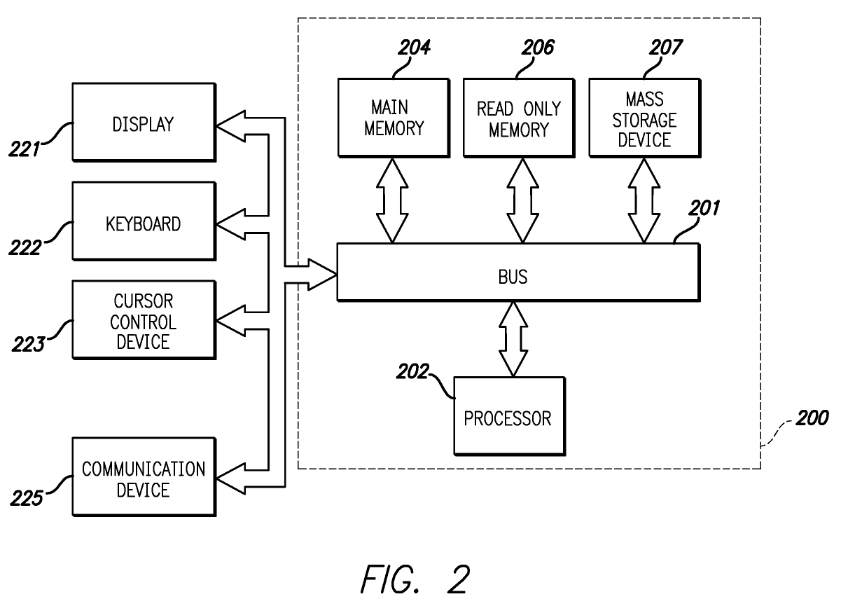

FIG. 2 illustrates an example of a computer system 200 in which the features of the present invention may be implemented. The computer system 200 includes a bus 201 for communicating information between the components in the computer system 200, and a processor 202 coupled with the bus 201 for executing software code, or instructions, and processing information. The computer system further comprises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during the execution of instructions by the processor 202. The computer system 200 also includes a read only memory (ROM) and/or other static storage device coupled to the bus 201 for storing static information and instructions for processor 202.

Another type of user input shown in the figure is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options. Various types of input devices, including, but not limited to the input devices described herein, unless otherwise noted, allow the person to provide command or input to the computer system 200. For example, in the various descriptions contained herein, reference may be made to the user “selecting,” “clicking,” or “inputting,” any grammatical variations thereof, one or more items in an interface. These should be understood to mean that the person is using one or more input devices to accomplish the input.

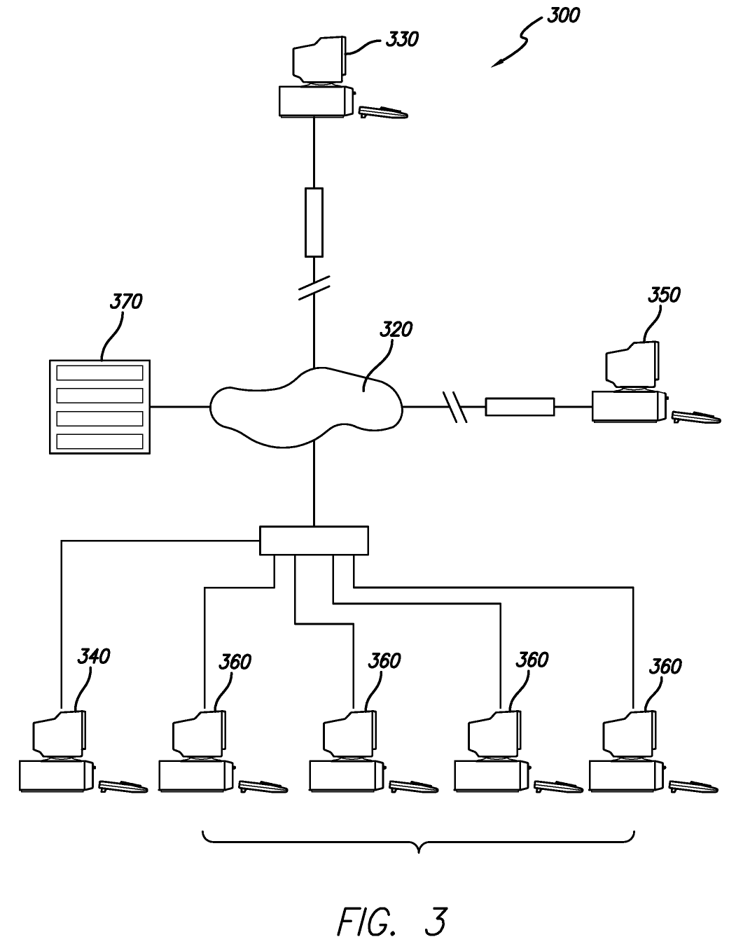

FIG. 3 illustrates a computer network 300 in accordance with one aspect of the present invention. In one embodiment, the person, such as a supervisor, may access the graphical user interface (GUI) 320, on an Internet website, using an Internet connection on a computer 330 outside the local area network. In another embodiment, the person, such as a supervisor, may access the graphical user interface (GUI) 320, on an Internet website, using an Internet connection on a computer 340 inside the local area network. In each of the foregoing embodiments, the monitored computers may be inside the local area network or the monitored computers may be outside the local area network. For ease of description, the monitored computers inside the local area network may be referred to individually or collectively as “360,” and the monitored computers outside the local area network may be referred to individually or collectively as “350.” As such, the person may use computer 330 to monitor computer 350 or 360, or both. Likewise, the person may use computer 340 to monitor computer 350 or 360, or both.

Computers 350 and 360 may be monitored without using a VPN (virtual private network) or any other tunneling technology. In addition, computers 350 and 360 may be monitored without being permanently connected to the Internet. As such, computers 350 and 360 may locally store the information processed by the software system and communicate the information to the secure web server 370 once connected to the Internet. It is to be understood that any number of computers may be monitored inside and/or outside of the local are network, and it is to be understood that computers both inside and outside of the local area network may be monitored at the same time. Further, the computers described in the foregoing may be computers having the characteristics of the computer system 200 described in FIG. 2.

As described above, and referring to FIGS. 1 and 3, the person may interact with the information stored in the database 120 through the GUI 102. In the following description, the GUI 102 is implemented using one or more web pages (which may be referred to herein as “pages,” “screens,” or “forms”) provided by the web server 370 accessible by the person using any Internet web browser software, such as Internet Explorer browser provided by Microsoft Corp., on a computer such as computer 330 or computer 340. In another embodiment, one or more custom software programs can be created to implement the system described herein. Of course, the web server 370 may itself have browser software installed on it so as to be accessed by the person. Further, throughout the description of the various embodiments of the invention herein, references are made to the person performing such actions as selecting buttons or clicking on, executing searches or updates on the database 120. In one preferred embodiment, these requests are generated by the person interacting with the browser. Preferably, the one or more web pages described herein may include a form interface (e.g., a drop down menu, a radio button selection, etc.). Once the person has provided such a selection, the person may select a button or a link on the web page to request an update of the database 120 with the information. The browser will send the web server 370 a link that includes the information (i.e., the person's selection) being sent as well as the request to update the database 120.

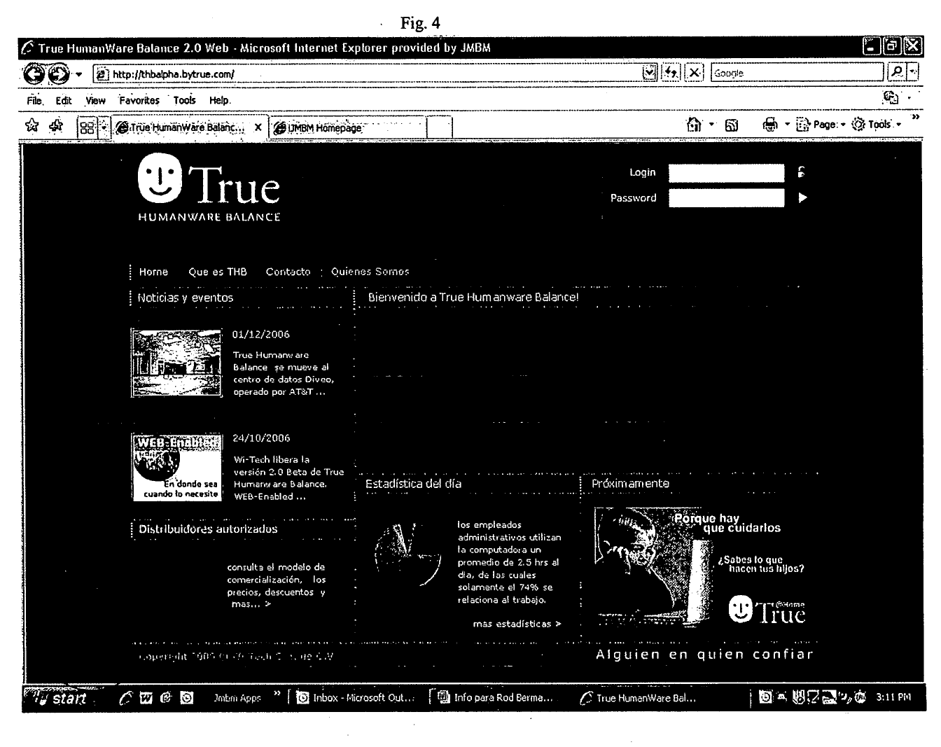

FIGS. 4-15 show screens from a website of the system and method of monitoring computer usage of a computer user. Techniques for programming computers to generate such screens are known. Any number of screen designs, layouts, and sequences may be used without departing from the scope of the present invention.

FIG. 4 illustrates an exemplary screenshot of a primary homepage of the method and system of monitoring computer usage 100. At this point, the person may log onto the website by inputting a LOG IN and PASSWORD. In an alternate embodiment, the person may not need to input a LOG IN and a PASSWORD and/or the homepage may have a means for registering a new user. In other embodiments, the person may not need to log onto the website.

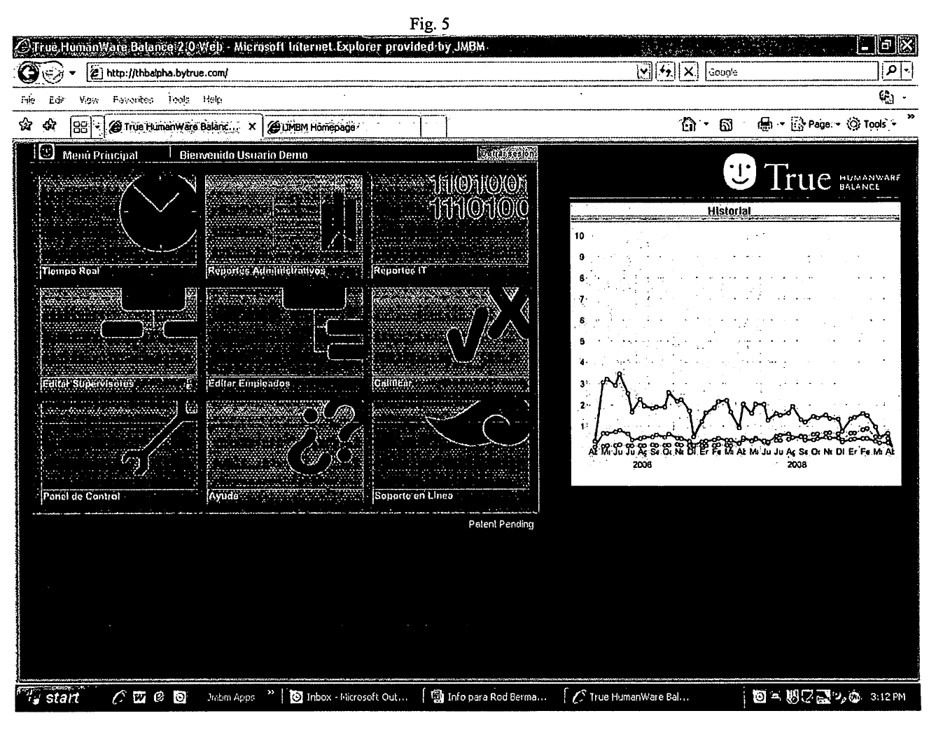

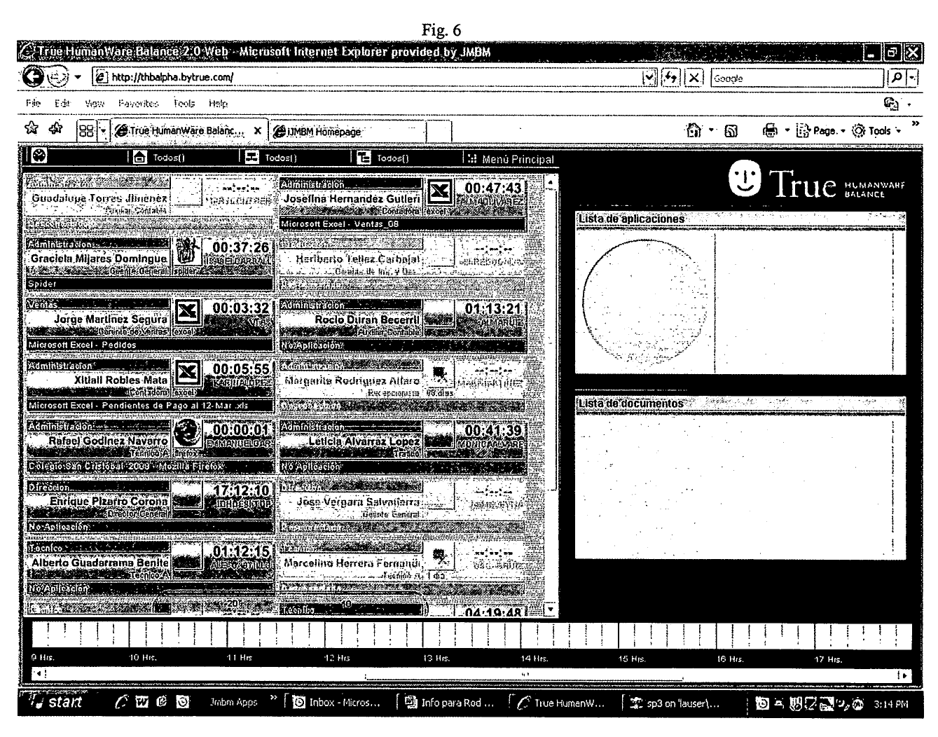

In a preferred embodiment, inputting a LOG IN and a PASSWORD directs the person to the webpage shown in FIG. 5. Preferably, the person is presented with a menu of choices. If the person wants to determine what sites/applications the monitored user(s) are using at that time, the person may select “Tiempo Real” (or “Real Time”). Selecting Real Time preferably directs the person to the web page shown in FIG. 6.

FIG. 6 shows a plurality of monitored users. As such, the present invention allows the person to monitor a number of users at one time. Preferably, the monitored users are employees and/or children. In the exemplary screen shot, 14 employees are monitored. In other embodiments, these users may be any other person or group, i.e., a spouse, student, a laboratory, or the like, without departing from the scope of the invention. Additionally, it is to be understood that any number of computer users may be inputted into the database and monitored. In other embodiments, the individuals themselves may not be identified. For example, if the person wants to monitor the efficiency of the team or department as a whole, the team or department's name may be identified instead. As such, the person is able to input what “identities” are displayed on the indicators.

The application or site used by each user at a given time is preferably displayed on the screen, i.e., besides the identity of the user. As shown in FIG. 6, the foregoing may be displayed in boxes. For ease of description, the boxes will be referred to herein as “indicators.” Preferably, the time the user has used the application or site is displayed on the indicator. Preferably, users that are not using their computers, or have left their computers for a predetermined amount of time, are displayed in a lighter shade. These are computers that “are not being used.” In another embodiment, any other means of visually differentiating the users that are using their respective computers from the users that are not using their computers for a predetermined amount of time may be used.

Preferably, the “predetermined amount of time” (also referred to herein as “idle time”) is 60 seconds. However, the “predetermined amount of time” may be any other time that is programmed by the person. For example, the “predetermined amount of time” may refer to any amount of time the person deems that the user is not using the computer. This amount of time may be programmed by the person, depending on, for example, the user's job description, occupation, age, or the like. As such, the person may program the software system to deem computers as “not being used” when they are idle for a default time of 60 seconds or idle for any other amount of time programmed by the person. Preferably, the “predetermined amount of time” is the amount of time that the computer itself is not being used (i.e., the keyboard is not being touched and/or the input device is not being used) by the user. As such, if the user is using the computer (i.e., touching the keyboard or using an input device), but not using any application or site, the indicator will preferably recite: “no application,” or the like. In other embodiments, the “predetermined amount of time” may be any other time that the user is not interacting with the computer, through voice-activation, touch, or any other type of human intervention.

As is used herein, the amount of time the user used the application or site is preferably not the amount of time that the application or site was simply open on the computer desktop. As such, the present invention differentiates between an application or site that was simply open (but not necessarily used) and one that was open and used. As such, the present invention tracks the time the application or site was open and used. It follows that an application or site that is not used (but may be open) at any given time is preferably not displayed on the indicator. In another embodiment, the indicator may display both the application or site the user is using, as well as the application or site the user has open on his or her desktop. If the user is using more than one application or site at a given time, the indicator may display the identities/amount of time used for each of them.

As discussed in the foregoing, the application or site used by the user is displayed on the indicator. Preferably, the indicator displays the “icon” for the application or site being used, as well as indicates whether the application or site is work-related, non-work-related, acceptable, unacceptable, useful, not useful, or the like. The methodology surrounding the classification of the applications/sites will be discussed in later. This allows for the person to quickly determine, for example, whether the employee is using the computer for work-related activities, or whether the child is using acceptable or unacceptable applications or sites. Preferably, if the application or site being used is work-related (or acceptable), then it is highlighted in green. If it is not work-related (or is unacceptable), it is highlighted in red. In other embodiments, any other means of differentiating between work-related and non work-related sites or applications (or differentiating between any other classification schemes) may be used without departing from the scope of the present invention.

In a preferred embodiment, the application and/or sites used by the user are identified in real time. Preferably, the user's use of an application or site is communicated to the web server about every 30 seconds. In other embodiments, the user's use of an application or site is communicated less than every 30 seconds, or greater than every 30 seconds. For example, the user's use may be communicated to the server from about every 10 seconds to about every 5 minutes, or from about every 10 seconds to about every 1 minute. The time interval that the usage information is communicated to the web server may be programmed by the person. As such, the person may program a first software system installed on a first monitored computer to communicate usage information every 30 sec., and the person may program a second software system installed on a second monitored computer to communicate usage information every 5 minutes. It follows that the person may monitor some users more frequently than others. All these users may appear on one screen. For example, in the case of an interface used in the workplace, a first employee may need to be monitored more than a second employee. As such, the software system on the first employee's computer may be programmed to communicate usage information every 20 sec., and the software system on the second employee's computer may be programmed to communicate usage information every 10 min. Both employees may be monitored simultaneously on one screen. As used herein, “usage information” may refer to the (1) identity of the application or site; and/or (2) the amount of time the monitored user has used the application or site. In other embodiments, “usage information” may refer to the applications or sites the user has opened and/or computer efficiency information.

In a preferred embodiment, the indicator does not display the contents of the application or site used by the user. However, some information regarding the identity of the application or site and/or the content of the application or site may he displayed. For example, if the user is using Internet Explorer, the identity of the actual website used may be displayed on the indicator. As a further example, the subject matter (say for example, the subject matter of an MSN messenger conversation) may be identified and displayed on the indicator.

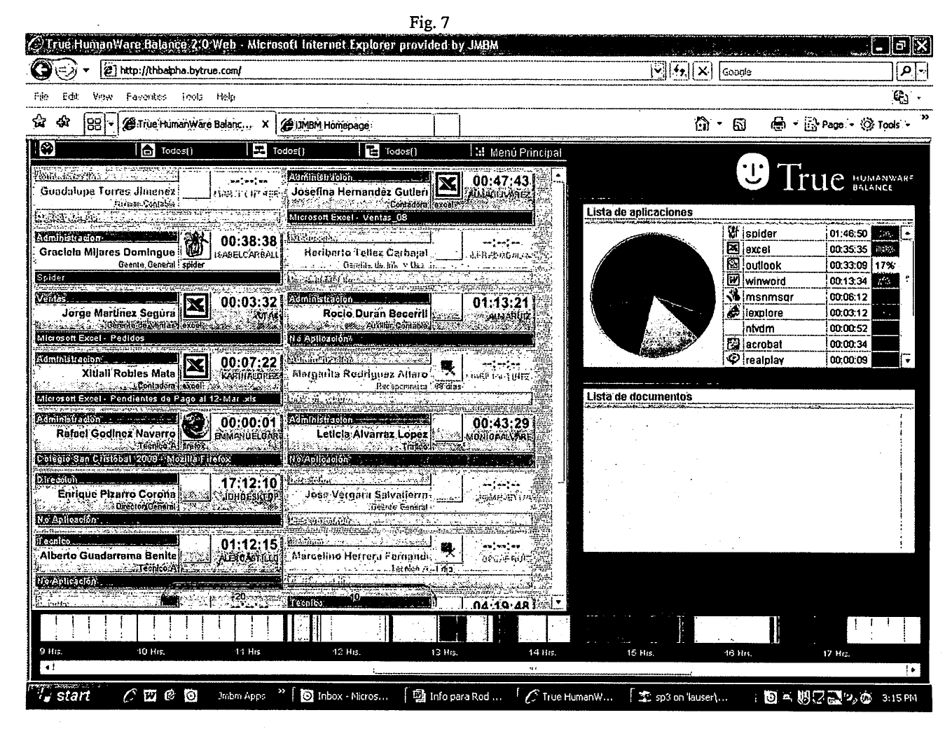

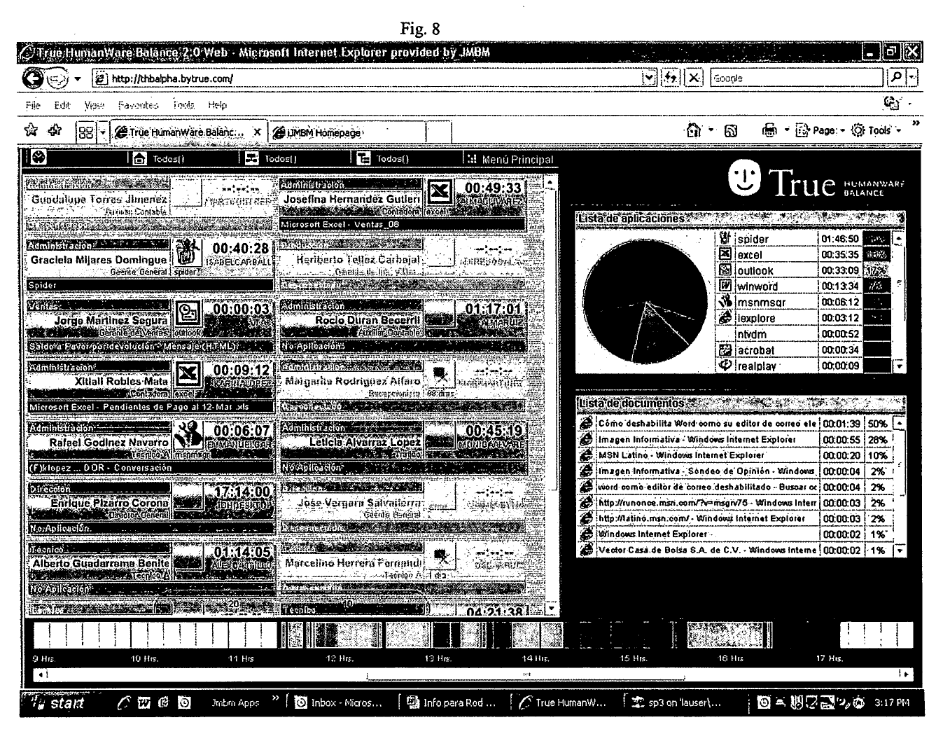

Selecting a user from the list of users in FIG. 6 preferably directs the person to the exemplary webpage as shown in FIG. 7. On the right side of the screen there is displayed a list of applications/sites used by the selected user and the amount of time the selected user has spent using each application/site. Preferably, this list is updated daily. In other embodiments, the list is updated at any other time interval. In a preferred embodiment, the amount of time the user has used each application or site that day is displayed pictorially, using a pie chart. In other embodiments, the amount of time may not displayed pictorially. Additionally, selecting an application from the list of applications preferably leads the user to a screen such as that shown in FIG. 8, which shows a list of documents used in the selected application on the lower right-hand side of the screen.

For instance, FIG. 8 is an exemplary screen shot of the web page displayed after the person selects the Internet Explorer application from the list of applications shown in FIG. 7. As such, a list of documents/sites used using Internet Explorer is displayed. For instance, the identity of the websites frequented by the user, as well as the amount of time spent using each site, is displayed. In other embodiments, the identities of the websites themselves are not displayed. In yet other embodiments, the classification of the websites, i.e., work-related or non work-related, may be displayed in lieu of, or in conjunction with, the identities of the websites themselves.

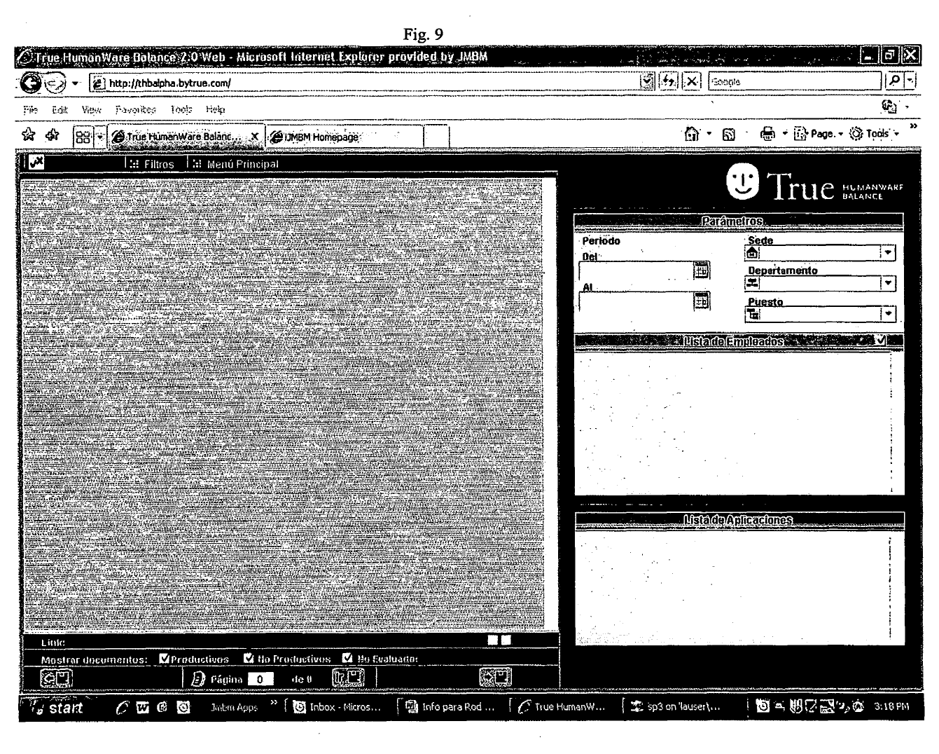

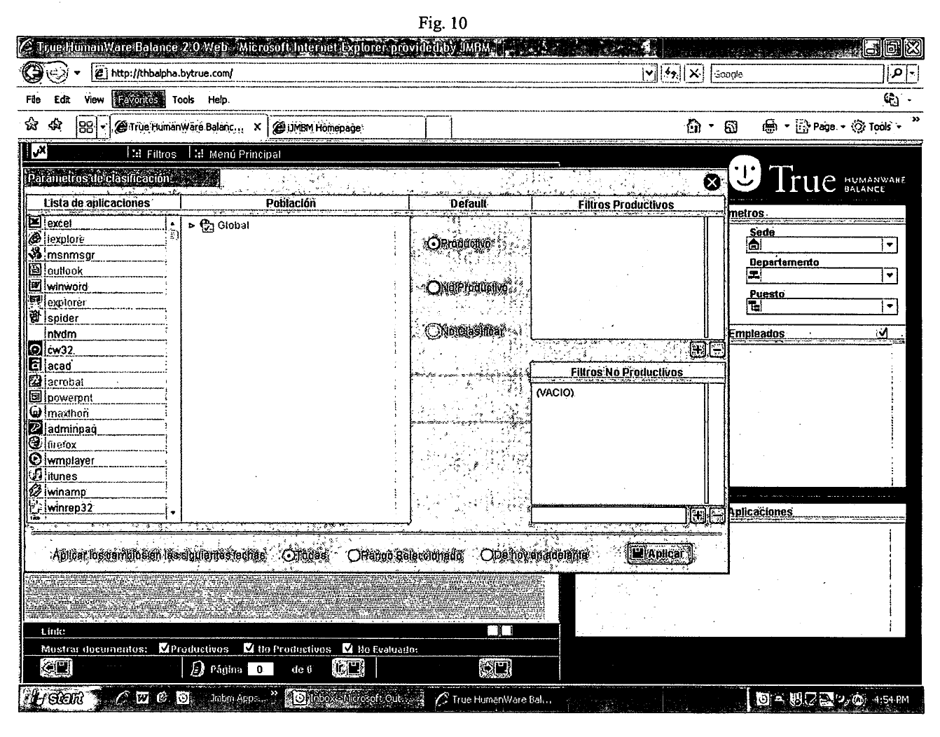

FIG. 9 is an exemplary screen shot after the person selects “Calificar” (“classification”) from the menu of choices of FIG. 2. Selecting “Filtros” or “Filters” as shown on the top left of FIG. 9 will direct the person to the screen as shown in FIG. 10. An exemplary list of applications/sites is displayed. More or less applications/sites may be entered and classified without departing from the scope of the present invention. Preferably, selecting an application or site allows the person to input a classification specific to that application or site. As shown in FIG. 10, the classification may be selected from the group comprising: Productive, Non-Productive, and No-Classification. For example, the person may select “Productive” from the group. Selecting productive allows the user to input non-productive filters, i.e., subject matter that the person deems non-productive. As such, all content would be deemed “Productive” unless it is specifically listed in the filter as Non-Productive (as used herein, the content listed may be referred to as “non-productive filter”). Preferably, applications/sites that are deemed predominantly productive could be subject to the non-productive filter. Likewise, the user may select “Non-Productive” from the group. Selecting non-productive allows the user to input productive filters. As such, all content would be deemed “Non-Productive” unless it is specifically listed in the filter as “Productive.” Preferably, applications/sites that are deemed predominantly non-productive may be subject to the productive filter. In other embodiments, the classification may be any other classification, such as, for example, Acceptable, Unacceptable, No Classification, or the like. The classification may be based on the interface used, i.e., home or office. Any number of classifications may be used, and any number of filters may be added and/or subtracted.

Since the system of the present invention may monitor any number of users, the person may prefer to classify the applications/sites used by each user differently, i.e., perhaps based upon departmental function, age, seniority, etc. As such, the classification and/or filters added may vary depending on the user. What may be deemed productive for one user may be deemed non-productive for another. It follows, for example, that an Internet website, i.e., www.hotwire.com, that is deemed productive for one department may be deemed unproductive for another. Selecting the application/site from the list in FIG. 10 and then subsequently selecting a department (or any other subpopulation of users from the “Population” column in FIG. 10) preferably allows the person to input filters specific for that application/site and department. In other embodiments, the list of departments can be further broken down to units, people, etc.

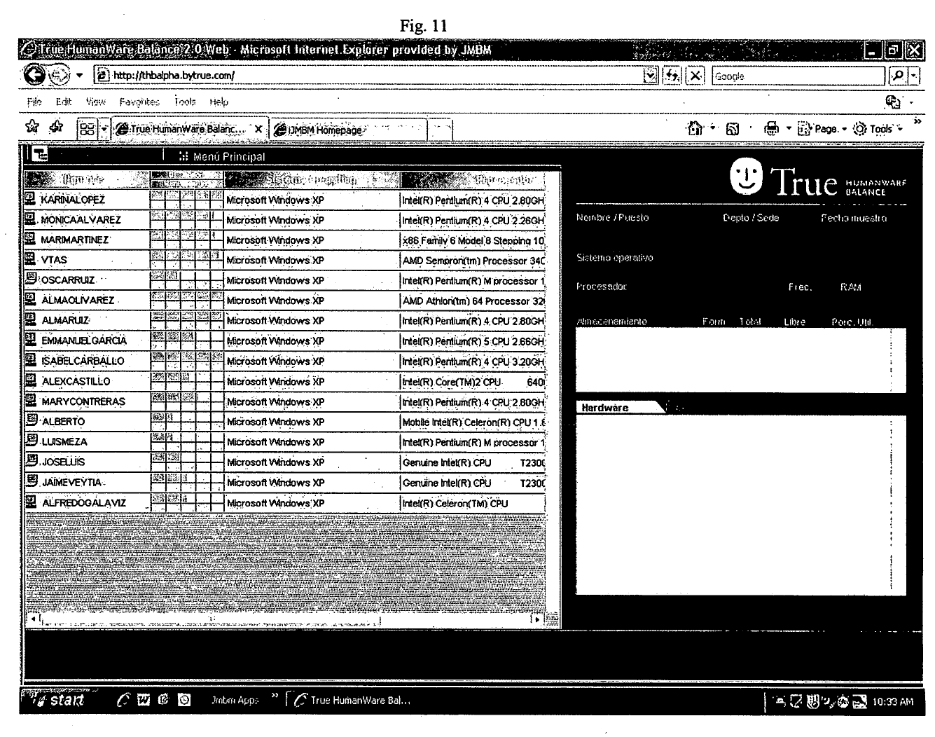

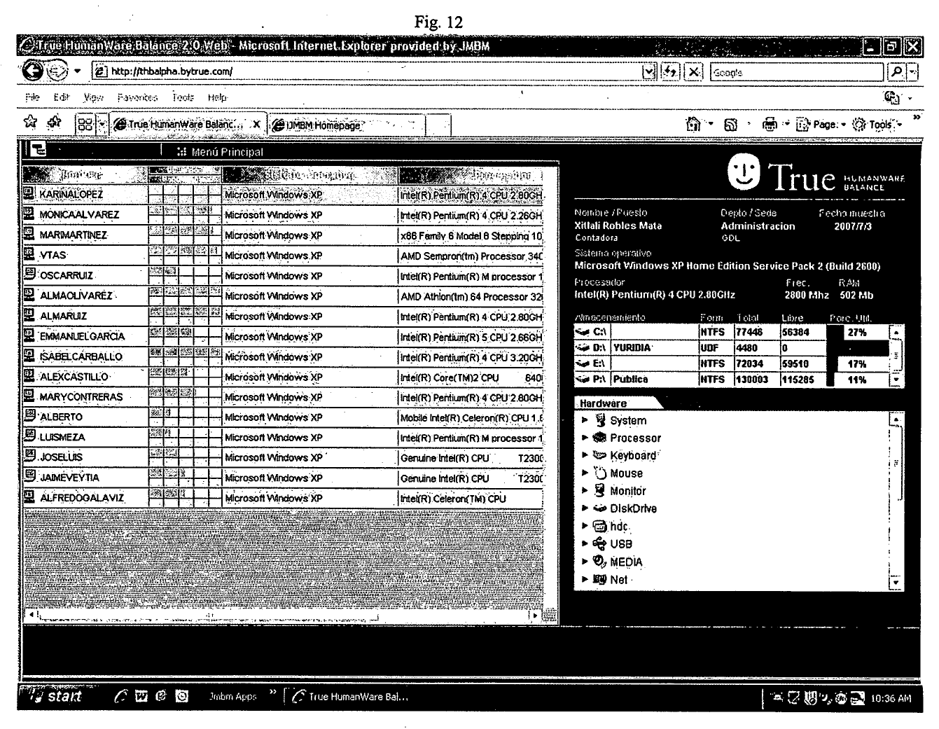

Selecting “Reports IT” from the menu as shown in FIG. 2, preferably directs the person to the screen shown in FIG. 11. This screen provides the user with computer efficiency information. The screen preferably displays a list of computers. The users of each of these computers may or may not be monitored. Preferably, the usage and performance of each computer is determined and displayed. The usage may be determined, for example, by the amount of time the computer is on and the user is touching the key board. Performance may be based on a number of different criteria as is known in the art, i.e., how fast/slow the computer is, or the like. Comparing the usage and performance allows the person to determine the computer efficiency of each computer. For example, a computer that has a greater usage than performance may be deemed an inefficient computer. Further, selecting a computer from the list of computers preferably directs the person to the screen as shown in FIG. 12. As shown in FIG. 12, a list of hardware installed on the selected computer is displayed. Likewise, selecting “software” provides the person with a list of software installed on the selected computer. As software and/or hardware is installed and/or removed, this list is updated. Information regarding the hardware/software installed on the computer may be sent to the server after a predetermined, configurable amount of time.

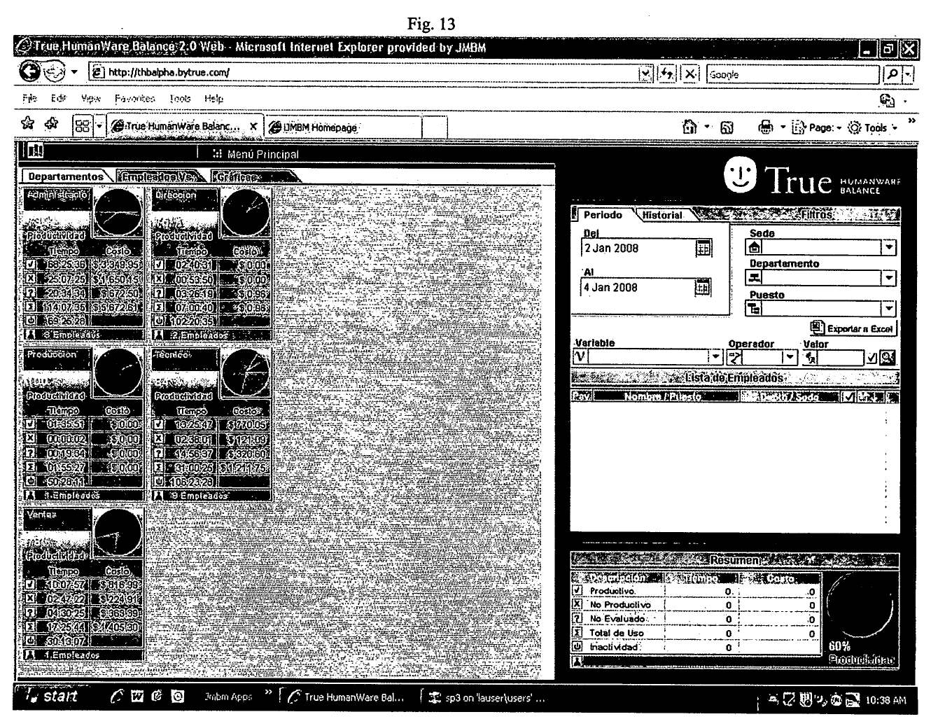

Selecting “Administrative Reports” from the menu of choices of FIG. 2, and subsequently entering a time period in the right-hand corner (as shown in FIG. 13) directs the person to the exemplary screen as shown in FIG. 13. The Administrative reports allow the person to determine and compare productivity rates, i.e., time spent on work-related applications and time spent on non work-related applications.

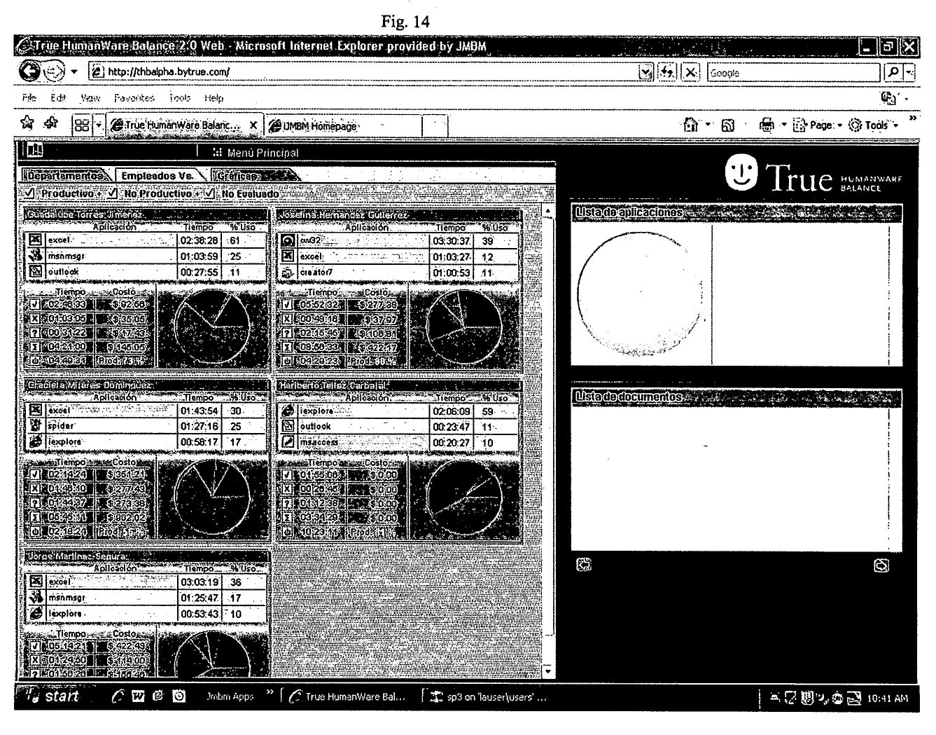

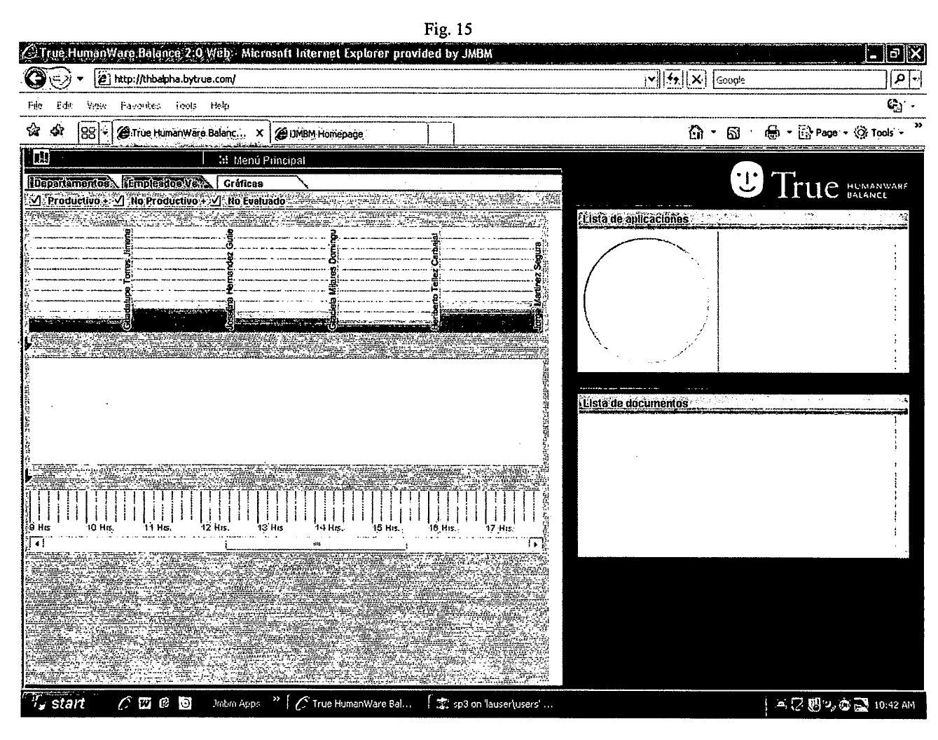

FIG. 13 shows a global report based upon department during the specified time interval. The reports may be generated globally (i.e., the entire company), by section/department, or by individual. The report preferably displays the percentage of time that was productive, percentage of time that was non-productive, and the like. Selecting “employees” from the choices on the upper right-side of FIG. 13 directs the person to the screen as shown in FIG. 14. Here, percentage productivity/non-productivity may be viewed by employee. Additionally, selecting “Graph” from FIG. 14 leads the person to the screen as show in FIG. 15. This interface preferably allows the person to analyze the employees' workload balance.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A method for monitoring a person's use of a computer, the method comprising:
(a) providing a website for monitoring the person's use of the computer;
(b) identifying an application or site the person is using;
(c) detecting when the person begins use of the application or the site;
(d) detecting when the person stops use of the application or the site;
wherein a difference between (d) and (c) is used to determine an amount of time the person used the application or the site.

2. The method of claim 1, further comprising displaying the application or the site used by the person on the website.

3. The method of claim 2, further comprising displaying the amount of time the person has used the application or the site on the website.

4. The method of claim 3, further comprising providing a list of people being monitored on the website.

5. The method of claim 4, further comprising providing a means for selecting a person from the list of people.

6. The method of claim 5, wherein the website does not display the contents of the application or the site.

7. The method of claim 1, further comprising detecting when the user opened the application or site, and when the user closed the application or site.

8. The method of claim 5, further comprising providing a list of applications or sites used by the person on a particular day upon selection of a person from the list of people.

9. The method of claim 8, further comprising providing the amount of time the person used each application or each site on the particular day.

10. The method of claim 1, wherein the amount of time is communicated to a server from about every 10 seconds to about every 5 minutes.

11. The method of claim 10, wherein the amount of time is communicated to the server from about every 10 seconds to about every 1 minute.

12. The method of claim 11, wherein the amount of time is communicated to the server about every 30 seconds.

13. A system for monitoring a computer user's use of a computer by a person, the system comprising:
(a) a database of at least one computer user;
(b) a software system for:
(i) identifying an application or site used by the computer user;
(ii) identifying when the user began use of the application or site; and
(iii) identifying when the user stopped use of the application or site;
(c) means for displaying the application or site of (i); wherein (ii) and (iii) is used to determine an amount of time the user is using the application or site.

14. The system of claim 13, wherein the software system provides the application or site of (i) and the time of (ii) and (iii) at specified time intervals.

15. The system of claim 14, wherein the means for displaying is an Internet website.

16. The system of claim 14, wherein the software system identifies when the user opened the application or site and when the user closed the application or site.

17. The system of claim 14, wherein the software system classifies the application or the site used by the user.

18. The system of claim 17, wherein the software system classifies the application or the site used by the user as acceptable or unacceptable, work-related, non-work-related, or no classification.

19. A method of providing computer user monitoring services to a person, the method comprising:
(a) providing a website for monitoring computer use;
(b) providing a list of applications or sites used by the computer user;
(c) providing means for selecting the application or the site from the list of applications or sites;
(d) providing means for selecting a classification; and
(e) providing means for adding filters to the classification.

20. The method of 19, further comprising providing a list of departments.

21. The method of claim 19, wherein the classification is selected from the group consisting of Productive, Non-Productive, and No Classification.

22. The method of claim 19, wherein the classification is selected from the group consisting of Acceptable, Not Acceptable, and No Classification.

23. The method of claim 19, wherein the means for selecting is a radial button.

24. The method of claim 21, wherein selecting productive allows the person to input non-productive filters.

25. The method of claim 21, wherein selecting non-productive allows the person to input productive filters.

26. The method of claim 20, further comprising a means for selecting a department from the list of departments.

27. A method for monitoring a user's use of at least one application software, the method comprising the steps of:
(a) providing a website;
(b) providing a database of application software;
(c) selecting an application software from the database that is being used by the user at a given time;
(d) detecting when the user begins use of the application software in (c);
(e) detecting when the user stops use of the application software in (c);
wherein a difference between (e) and (d) is used to determine a time the user used the application software chosen from (b).

28. A method of providing computer efficiency information to a person, the method comprising:
(a) providing a list of computers;
(b) determining performance of the computers;
(c) determining usage of the computers; and
(d) comparing (b) and (c).

29. The method of claim 28, further comprising providing the person a means of selecting a computer from the list of computers.

30. The method of claim 29, further comprising providing a list of hardware or a list of software installed in the computer upon selecting the computer of the list of computers.

31. A system for determining computer efficiency, the system comprising:
(a) a database of computers;
(b) software system for determining computer usage of a computer user and computer performance; and
means for displaying the computers of (a) and the usage and performance of (b).

32. The system of claim 31, wherein the means for displaying is an Internet website.
